(19) United States
(12) Patent Application Publication
(10) Pub. No.: US 2010/0169377 A1
(43) Pub. Date: Jul. 1, 2010

(54) SYSTEM, METHOD, AND COMPUTER-READABLE MEDIUM FOR FACILITATING APPLICATION VIRTUAL DATABASE USERS

(76) Inventors: Debra Galeazzi, La Quinta, CA (US); James Browning, Columbia, SC (US); Douglas P. Brown, Rancho Santa Fe, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/346,568

(22) Filed: Dec. 30, 2008

(51) Int. Cl. G06F 17/30

(52) U.S. Cl. 707/781; 707/E17.005; 707/E17.009

(57) ABSTRACT

A system, method, and computer-readable medium that provide virtual user access to a database system are provided. Middle-tier application end users issue requests to a middle-tier application that submits the requests to a database system on behalf of the middle-tier end users. The middle-tier application may authenticate end users and maintain a session pool for maintaining sessions with the database system for virtual users comprising valid middle-tier application end users. The middle-tier application is able to assert the identity of virtual users corresponding to the end users for use in access rights checking and auditing of queries without establishing a new logon session for the user. To facilitate middle-tier application assertion of virtual user identities, the middle-tier application is registered as a valid database user with the database system.

### BACKGROUND

A database is a collection of stored data that is logically related and that is accessible by one or more users or applications. A popular type of database is the relational database management system (RDBMS), which includes relational tables, also referred to as relations, made up of rows and columns (also referred to as tuples and attributes). Each row represents an occurrence of an entity defined by a table, with an entity being a person, place, thing, or other object about which the table contains information.

One of the goals of a database management system is to optimize the performance of queries for access and manipulation of data stored in the database. Given a target environment, an optimal query plan is selected, with the optimal query plan being the one with the lowest cost, e.g., response time, as determined by an optimizer. The response time is the amount of time it takes to complete the execution of a query on a given system.

Middle-tier applications often connect to back-end databases using connection pools to improve performance and resource utilization when servicing a large number of clients. However, many security standards require that end-users be uniquely identified to the back-end database for purposes of authorization and auditing. The middle-tier applications may have thousands of end-users. Consequently, significant overhead is disadvantageously introduced to the database system for the back-end authorization of the end-users.

### SUMMARY

Disclosed embodiments provide a system, method, and computer readable medium for providing virtual user access to a database system. Middle-tier application end users issue requests to a middle-tier application that submits the requests to a database system on behalf of the middle-tier end users. The middle-tier application may authenticate end users and maintain a session pool for maintaining sessions with the database system for virtual users comprising valid middle-tier application end users. The middle-tier application is able to assert the identity of virtual users corresponding to the end users for use in access rights checking and auditing of queries without establishing a new logon session for the user. To facilitate middle-tier application assertion of virtual user identities, the middle-tier application is registered as a valid database user with the database system.

### BRIEF DESCRIPTION OF THE DRAWINGS

Aspects of the present disclosure are best understood from the following detailed description when read with the accompanying figures, in which:

FIG. 1 depicts a diagrammatic representation of an exemplary architecture for a large database system that is suited for implementing access of virtual users to a database system in accordance with disclosed embodiments;

FIG. 2 depicts a diagrammatic representation of a sample architecture for one node of the system depicted in FIG. 1;

FIG. 3 is a diagrammatic representation of a parsing engine implemented in accordance with an embodiment;

FIG. 4 is a diagrammatic representation of a parser implemented in accordance with an embodiment;

FIG. 5 is a flowchart of a middle-tier application virtual database user processing routine implemented in accordance with disclosed embodiments; and

FIG. 6 is a flowchart of a virtual database user processing routine implemented in accordance with disclosed embodiments

### DETAILED DESCRIPTION

It is to be understood that the following disclosure provides many different embodiments or examples for implementing different features of various embodiments. Specific examples of components and arrangements are described below to simplify the present disclosure. These are, of course, merely examples and are not intended to be limiting.

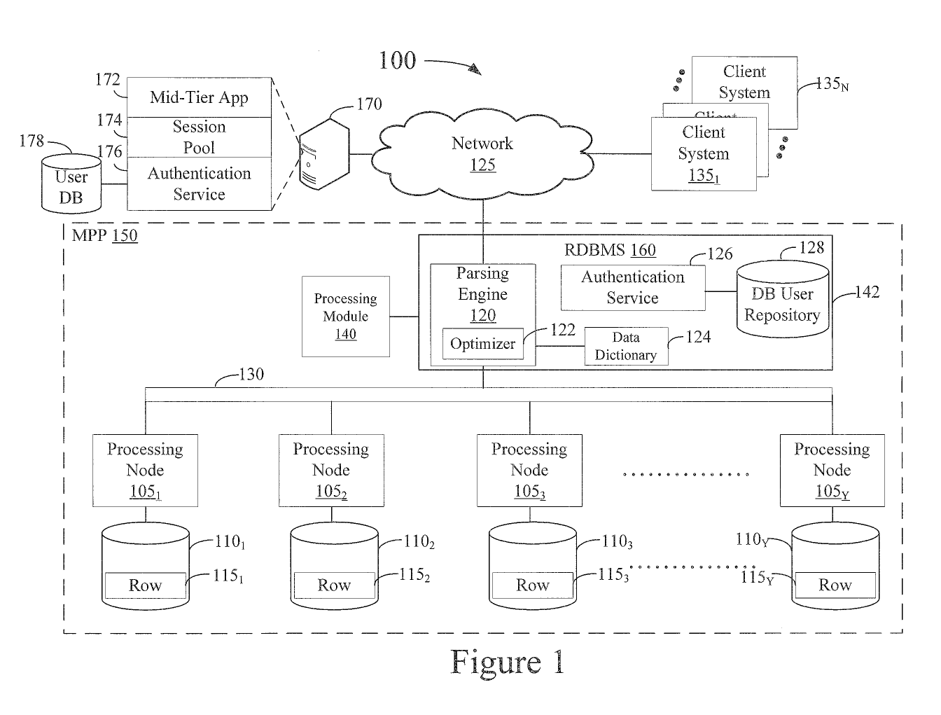

FIG. 1 depicts a diagrammatic representation of an exemplary architecture for a large database system 100, such as a Teradata Active Data Warehouse System, that is suited for implementing access of virtual users to a database system in accordance with disclosed embodiments. The database system 100 includes a relational database management system (RDBMS) 160 built upon a massively parallel processing (MPP) system 150.

As shown, the database system 100 includes one or more processing nodes 105_{1 . . . Y} that manage the storage and retrieval of data in data-storage facilities 110_{1 . . . Y}. Each of the processing nodes may host one or more physical or virtual processing modules, such as one or more access module processors (AMPs). Each of the processing nodes 105_{1 . . . Y} manages a portion of a database that is stored in a corresponding one of the data-storage facilities 110_{1 . . . Y}. Each of the data-storage facilities 110_{1 . . . Y} includes one or more disk drives or other storage medium.

The system stores data in one or more tables in the data-storage facilities 110_{1 . . . Y}. The rows 115_{1 . . . Y} of the tables are stored across multiple data-storage facilities 110_{1 . . . Y} to ensure that the system workload is distributed evenly across the processing nodes 105_{1 . . . Y}. A parsing engine 120 organizes the storage of data and the distribution of table rows 115_{1 . . . Y} among the processing nodes 105_{1 . . . Y} and accesses processing nodes 105_{1 . . . Y} via an interconnect 130. The parsing engine 120 also coordinates the retrieval of data from the data-storage facilities 110_{1 . . . Y} in response to queries received from a user or processing entity, such as requests received from a middle-tier application server 170.

The parsing engine 120, on receiving an incoming database query, may apply a session controller that invokes an RDBMS authentication service 126 for authenticating the entity that issued the request. To this end, the authentication service 126 is communicatively coupled with a database user repository 128 that stores database user authentication data, such as user names and credentials. The parser may then apply an optimizer 122 component to the query to assess the best plan for execution of the query. Selecting the optimal query execution plan includes, among other things, identifying which of the processing nodes 105_{1 . . . Y} are involved in executing the query and which database tables are involved in the query, as well as choosing which data-manipulation techniques will serve best in satisfying the conditions of the query. To this end, the parser and/or optimizer may access a data dictionary 124 that specifies the organization, contents, and conventions of one or more databases. For example, the data dictionary 124 may specify the names and descriptions of various tables maintained by the MPP system 150 as well as fields of each database. Further, the data dictionary 124 may specify the type, length, and/or other various characteristics of the stored tables. The database system typically receives queries in a standard format, such as the Structured Query Language (SQL) put forth by the American National Standards Institute (ANSI).

Various middle-tier application end users, such as users or processing entities operating at client systems 135₁-135_{N}, e.g., computer systems, ATM systems, or any other data processing system that may issue requests to a middle-tier application 172 hosted by an application server 170, may issue database requests to the middle-tier application 172 that, in turn, submits the request to the RDBMS 160 on behalf of the middle-tier end users. In this manner, end-users or entities at client systems 135₁-135_{N} are end users of the middle-tier application 172 and virtual users of the RDBMS 160. To this end, the application server 170 may include or interface with an authentication service 176 that authenticates application end users at clients systems 135₁-135_{N}. Valid middle-tier application end users may have authentication data, such as middle-tier application user names and credentials, stored in a user database 178 that is communicatively coupled with the authentication service 176. The application end users at client systems 135₁-135_{N} may access the application server 170 by, for example, a network 125 connection. In accordance with disclosed embodiments, the application server 170 may maintain a session pool 174 for maintaining sessions with the RDBMS 160 for virtual users at client systems 135₁-135_{N} and provides the capability for the middle-tier application 172 to assert the identity of virtual users for use in access rights checking and auditing of queries without establishing a new logon session for the user as described more fully hereinbelow. To facilitate middle-tier application 172 assertion of virtual user identities, the middle-tier application 172 is registered as a valid database user with the RDBMS 160. For instance, the middle-tier application 172 may have a unique database user name assigned thereto that is managed by the RDBMS 160, e.g., stored in the database user repository 128.

The parsing engine 120, data dictionary 124, and authentication service 126 may be implemented as computer-executable instruction sets tangibly embodied on a computer-readable medium, such as a memory device 142, that are retrieved by a processing module 140 and processed thereby in accordance with disclosed embodiments.

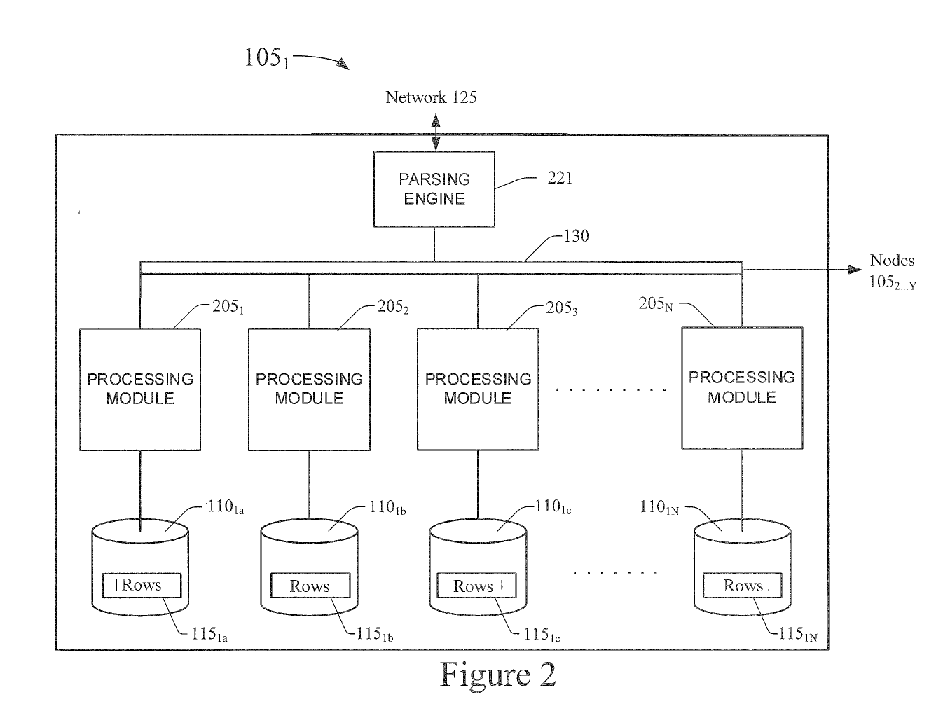

FIG. 2 depicts a diagrammatic representation of a sample architecture for one node 105₁ of the DBS 100. The DBS node 105₁ includes one or more processing modules 205_{1 . . . N} connected by an interconnect 130 that manage the storage and retrieval of data in data-storage facilities 110_{1a . . . 1N}. Each of the processing modules 205_{1 . . . N} may be one or more physical processors or each may be a virtual processor, with one or more virtual processors running on one or more physical processors. For the case in which one or more virtual processors are running on a single physical processor, the single physical processor swaps between the set of N virtual processors. For the case in which N virtual processors are running on an M-processor node, the node's operating system schedules the N virtual processors to run on its set of M physical processors. If there are 4 virtual processors and 4 physical processors, then typically each virtual processor would run on its own physical processor. If there are 8 virtual processors and 4 physical processors, the operating system would schedule the 8 virtual processors against the 4 physical processors, in which case swapping of the virtual processors would occur.

Each of the processing modules 205_{1 . . . N} manages a portion of a database that is stored in a corresponding one of the data-storage facilities 101_{1a . . . 1N}. Each of the data-storage facilities 110_{1a . . . 1N} includes one or more disk drives. The DBS may include multiple nodes 105_{2 . . . Y} in addition to the illustrated node 105₁, connected by way of the interconnect 130.

The system stores data in one or more tables in the data-storage facilities 110_{1a . . . 1N}. The rows 115_{1a . . . 1N} of the tables are stored across multiple data-storage facilities 110_{1a . . . 1N} to ensure that the system workload is distributed evenly across the processing modules 205_{1 . . . N}. A parsing engine 221 organizes the storage of data and the distribution of table rows 110_{1a . . . 1N} among the processing modules 205_{1 . . . N}. The parsing engine 221 also coordinates the retrieval of data from the data-storage facilities 110_{1a . . . 1N} in response to queries received from a user at a client computer system 135_{1 . . . N}. The DBS 100 usually receives queries and commands to build tables in a standard format, such as SQL.

In one implementation, the rows 115_{1a . . . 1N} are distributed across the data-storage facilities 110_{1a . . . 1N} by the parsing engine 221 in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to data-storage facilities 110_{1a . . . 1N} and associated processing modules 205_{1 . . . N} by a hash bucket map. The characteristics of the columns chosen for the primary index determine how evenly the rows are distributed.

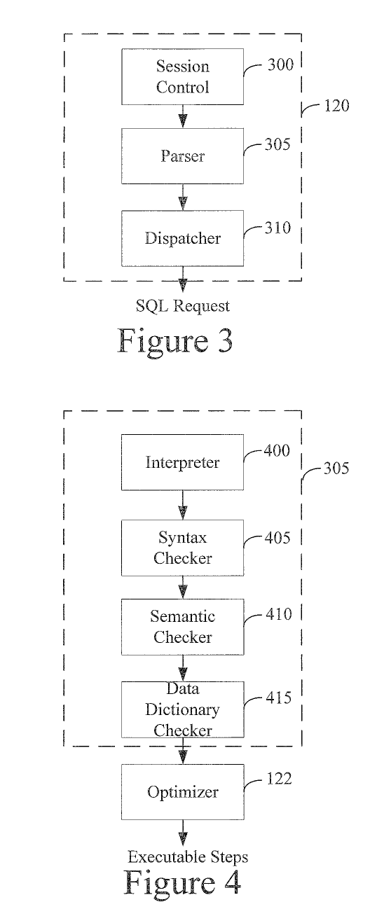

In one example system, a parsing engine, such as the parsing engine 120, is made up of three components: a session control 300, a parser 305, and a dispatcher 310 as shown in FIG. 3. The session control 300 provides the logon and logoff functions. It accepts a request for authorization to access the database, verifies it, and then either allows or disallows the access. Once the session control 300 allows a session to begin, a user may submit a SQL request that is routed to the parser 305. As illustrated in FIG. 4, the parser 305 interprets the SQL request (block 400), checks the request for correct SQL syntax (block 405), evaluates the request semantically (block 410), and consults a data dictionary to ensure that all of the objects specified in the SQL request exist and that the user has the authority to perform the request (block 415). Finally, the parser 305 runs the optimizer 122 that selects the least expensive plan to perform the request.

In accordance with disclosed embodiments, a virtual user, e.g., a user issuing queries to the middle-tier application 172 from a client system 135₁-135_{N} that are to be submitted to the RDBMS 160 by the application 172 on behalf of the virtual user, does not have a database logon account with the RDBMS 160. Advantageously, there is no maintenance of passwords, database space, etc., for the virtual user.

In accordance with an embodiment, a virtual user is created by an SQL statement that defines the virtual user name corresponding to a middle-tier application end user, a database user name that can assert the identity of the virtual user, and roles assigned to the virtual user. Roles are sets of access rights, e.g., query rights, table access rights, etc. An exemplary SQL statement for configuring such access may be implemented according to the following:
GRANT CONNECT THROUGH database_user_name
TO virtual_user_name1 . . . virtual_user_nameX
WITH ROLE rolename1 . . . rolenameY;

On receipt of the GRANT CONNECT THROUGH statement, the RDBMS 160 may allocate records in the database user repository 128 that associates the specified virtual user names (virtual_user_name1—virtual_user_nameX in the above example) with the specified roles. The virtual user names and roles are further associated with the database_user_name in the database user repository 128. The database_user_name comprises a valid RDBMS user name of an entity authorized to access the RDBMS 160 and is assigned to the middle-tier application 172 that will submit requests to the RDBMS 160 on behalf of virtual users. In this manner, the GRANT CONNECT THROUGH statement serves to authorize the middle-tier application 172 to assert the identity and role(s) of virtual users. Each virtual user is unique to the specified database user name, and only when an application is logged on to the database with the database user name can the identity of the virtual user be asserted.

The middle-tier application 172 creates a session pool 174 authenticating itself to the database as the database user name assigned to the middle-tier application 172. The RDBMS 160 validates the database user name assigned to the application 172, e.g., by invoking the RDBMS authentication service 126 that validates the database user name assigned to the application 172 by interrogating the database user repository 128.

An application end user, e.g., at a client system 135₁-135_{N}, authenticates itself to the middle-tier application 172 and requests a service requiring one or more queries to the database system. The middle-tier application 172, in turn, may validate the end user by invoking the authentication service 176 that evaluates the end user credentials with the user database 178. The middle-tier application 172 sets the identity of the database connection to that of the virtual user name assigned to the application end user. For example, the application 172 may set the identity of the connection to that of the virtual user by an SQL statement such as the following:

SET QUERY_BAND=‘PROXYUSER=virtual_user_name;PROXYROLE=role_name;’

FOR SESSION;

The RDBMS 160 then verifies that the virtual user is a valid virtual user for the current database connection, e.g., by validating the virtual user name is associated with the database user name assigned to the application 172 that is establishing the connection. Assuming the RDBMS satisfactorily verifies that the virtual user is a valid virtual user, the middle-tier application 172 submits queries to the RDBMS 160 on behalf of the application end user. The RDBMS 160 then verifies access rights for the query based upon the virtual user's roles specified with the identity of the virtual user. Assuming the role has suitable access rights for the specified query, the RDBMS 160 may then process the query and return results to the application 172. The RDBMS 160 may record the virtual user identity in any records inserted for audit logging.

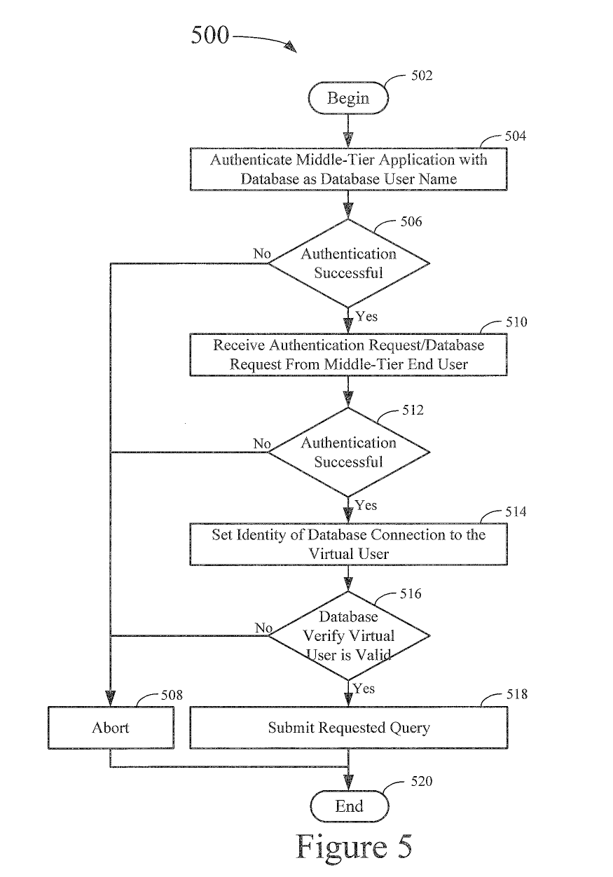

FIG. 5 is a flowchart 500 of a middle-tier application virtual database user processing routine implemented in accordance with disclosed embodiments. The processing steps of FIG. 5 may be implemented as computer-executable instructions tangibly embodied on a computer-readable medium executable by a processing system, such as the application server 170 that hosts a middle-tier application depicted in FIG. 1.

The middle-tier application processing routine is invoked (step 502), and the middle-tier application 172 creates a session pool 174 and requests authentication to the RDBMS 160 with the database user name assigned to the application 172 (step 504). The application 172 may then await confirmation of authentication by the RDBMS and evaluate if the authentication was successful (step 506). If the authentication with the RDBMS 160 was unsuccessful, the application processing routine may then abort (step 508), and the processing routine cycle may then end (step 520).

If the application 172 is successfully authenticated by the RDBMS 160, the application processing routine may then receive an authentication request and database request from an application end user, such as a user or processing entity at a client system 135₁-135_{N} (step 510). For example, a client system 135₁-135_{N} may submit a user name or other authentication data with which the client system 135₁-135_{N} may be validated by the middle-tier application 172. The middle-tier application 172 may then attempt to validate the application end user with the application 172, e.g., by invoking the authentication service 176 and supplying the end user credential thereto for evaluation with the user database 178. The middle-tier application then evaluates whether the end user was successfully authenticated (step 512). If the end user does not successfully authenticate with the middle-tier application, the middle-tier application processing routine may abort according to step 508.

If the end user successfully authenticates with the middle-tier application, the middle-tier application 172 may then set the identity of a connection with the RDBMS 160 to the virtual user (step 514), e.g., by issuing the SET QUERY_BAND statement discussed hereinabove with the virtual user name assigned to the middle-tier application end user. The middle-tier application 172 then awaits a confirmation or rejection of validation of the virtual user from the RDBMS and evaluates whether the end user was successfully validated by the RDBMS 160 (step 516). If the virtual user is not successfully validated by the RDBMS, the middle-tier application processing routine may abort according to step 508.

If the virtual user is successfully validated by the RDBMS, the middle-tier application 172 may then submit the database request to the RDBMS on behalf of the end user and await receipt of the request results (step 518). The middle-tier application processing routine cycle may then end according to step 520.

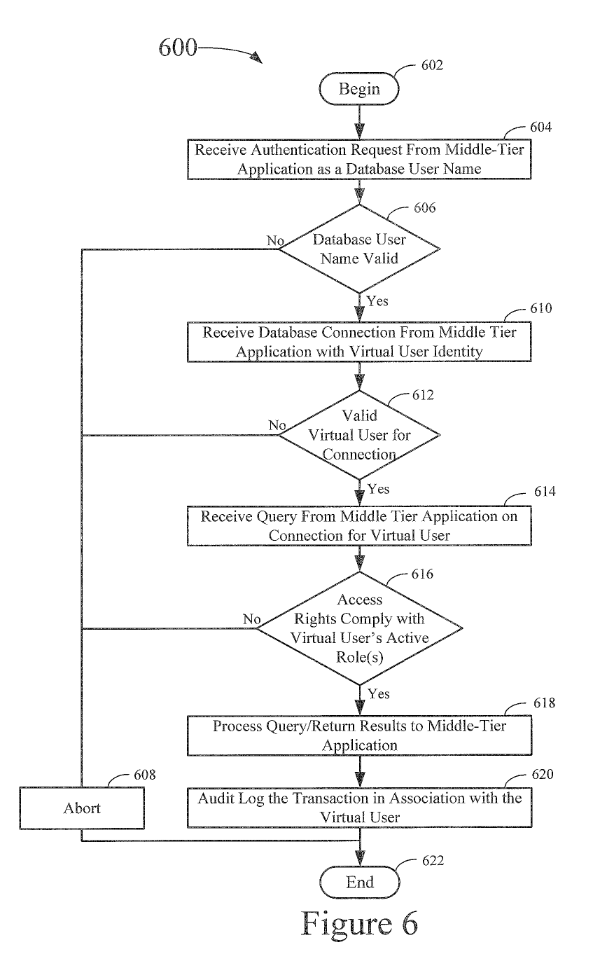

FIG. 6 is a flowchart 600 of a virtual database user processing routine implemented in accordance with disclosed embodiments. The processing steps of FIG. 6 may be implemented as computer-executable instructions tangibly embodied on a computer-readable medium executable by a processing system, such as the processing module 140 depicted in FIG. 1.

The database user processing routine is invoked (step 602), and the RDBMS 160 receives an authentication request from the middle-tier application 172 as the database user name assigned to the application 172 (step 604). The RDBMS 160 then attempts to validate the middle-tier application, e.g., by invoking the RDBMS authentication service 126 that evaluates the database user name submitted to the RDBMS by the middle-tier application with the database user repository 128. An evaluation is then made to determine if the database user name is valid (step 606). If the database user name is not successfully validated, the database user processing routine may abort (step 608), and the database user processing routine cycle may then end (step 622).

If the database user name is successfully validated, the RDBMS 160 may then receive a database connection from the successfully validated middle-tier application 172 with the connection identity set to the virtual user identity (step 610), i.e., the virtual user name assigned to the middle-tier application end user that submitted the request to the middle-tier application 172. The RDBMS may then evaluate whether the virtual user of the connection is valid (step 612). If the virtual user is not validated, the database user processing routine may then abort according to step 608. If the virtual user is validated, the RDBMS then receives the query on the connection from the middle-tier application 172 submitted thereby on behalf of the corresponding middle-tier application end user (step 614). The RDBMS then evaluates whether the virtual user's access rights comply with the submitted query (step 616), e.g., by evaluating the virtual user's role(s) maintained in the database user repository 128. If the virtual user's access rights do not comply with the submitted query, the database user processing routine may then abort according to step 608. If the virtual user's access rights comply with the submitted query, the RDBMS may then process the query and return results to the middle-tier application 172 (step 618). The RDBMS may additionally audit log the database transaction in association with the virtual user (step 620). The database user processing routine cycle may then end according to step 622.

In accordance with another embodiment, the virtual user may be set for the life of the transaction. The virtual user is used for access rights checking and audit logging. Setting the virtual user for the transaction is fast as all virtual user data is stored in memory and does not need to be saved on disk. Once the transaction is ended by commit, rollback, or abort, the virtual user data is automatically discarded (e.g., Spool, Response answer sets, etc.) so cleanup is automatic. Further, the virtual user may also be changed during the transaction. When the transaction is ended by a commit or abort, the virtual user assertion is removed and the database connection is returned to the state of the originally logged on database user.

As described, middle-tier application end users may issue requests to a middle-tier application that submits the requests to a database system on behalf of the middle-tier end users. The middle-tier application may authenticate end users and maintain a session pool for maintaining sessions with the database system for virtual users comprising valid middle-tier application end users. The middle-tier application is able to assert the identity of virtual users corresponding to the end users for use in access rights checking and auditing of queries without establishing a new logon session for the user. To facilitate middle-tier application assertion of virtual user identities, the middle-tier application is registered as a valid database user with the database system.

The flowcharts of FIGS. 5-6 depict process serialization to facilitate an understanding of disclosed embodiments and are not necessarily indicative of the serialization of the operations being performed. In various embodiments, the processing steps described in FIGS. 5-6 may be performed in varying order, and one or more depicted steps may be performed in parallel with other steps. Additionally, execution of some processing steps of FIGS. 5-6 may be excluded without departing from embodiments disclosed herein.

The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the disclosed embodiments may be implemented in software, hardware, firmware, or a combination thereof. The various elements of the system, either individually or in combination, may be implemented as a computer program product tangibly embodied in a machine-readable storage device for execution by a processing unit. Various steps of embodiments may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying aspects of the disclosed embodiments can be loaded onto a computer. The computer program is not limited to any particular embodiment, and may, for example, be implemented in an operating system, application program, foreground or background process, or any combination thereof, executing on a single processor or multiple processors. Additionally, various steps of embodiments may provide one or more data structures generated, produced, received, or otherwise implemented on a computer-readable medium, such as a memory.

Although disclosed embodiments have been illustrated in the accompanying drawings and described in the foregoing description, it will be understood that embodiments are not limited to the disclosed examples, but are capable of numerous rearrangements, modifications, and substitutions without departing from the disclosed embodiments as set forth and defined by the following claims. For example, the capabilities of the disclosed embodiments can be performed fully and/or partially by one or more of the blocks, modules, processors or memories. Also, these capabilities may be performed in the current manner or in a distributed manner and on, or via, any device able to provide and/or receive information. Still further, although depicted in a particular manner, a greater or lesser number of modules and connections can be utilized with the present disclosure in order to accomplish embodiments, to provide additional known features to present embodiments, and/or to make disclosed embodiments more efficient. Also, the information sent between various modules can be sent between the modules via at least one of a data network, an Internet Protocol network, a wireless source, and a wired source and via a plurality of protocols.

What is claimed is:

1. A method of providing virtual access to a database system deployed in a computer system by a middle-tier application, comprising:
registering the middle-tier application with the database system with a database user name;
receiving, by the middle-tier application, a request to be processed in the database system from a client system configured as an end user to the middle-tier application;
asserting, by the middle-tier application, an identity of a connection between the middle-tier application and the database system as a virtual user corresponding to the end user; and
submitting, by the middle-tier application, the request to the database system on the connection.

2. The method of claim 1, further comprising:
authenticating, by the middle-tier application, the end user with the middle-tier application; and
creating, by the middle-tier application, a session pool that includes the connection.

3. The method of claim 1, further comprising:
associating the database user name with the virtual user; and
recording one or more roles that specify database access rights of the virtual user.

4. The method of claim 3, wherein creating the virtual user comprises creating a plurality of virtual users each corresponding to one of a plurality of end users of the middle-tier application.

5. The method of claim 1, further comprising verifying, by the database system, the virtual user is a valid virtual user.

6. The method of claim 1, further comprising verifying, by the database system, that the request complies with the database access rights of the virtual user's role.

7. The method of claim 1, further comprising authenticating, by the database system, the middle-tier application as a valid user of the database system.

8. A computer-readable medium having computer-executable instructions for execution by a processing system, the computer-executable instructions for providing virtual access to a database system deployed in a computer system by a middle-tier application, the computer-executable instructions, when executed, cause the processing system to:
register the middle-tier application with the database system with a database user name;
receive, by the middle-tier application, a request to be processed in the database system from a client system configured as an end user to the middle-tier application;
assert, by the middle-tier application, an identity of a connection between the middle-tier application and the database system as a virtual user corresponding to the end user;
assert, by the middle-tier application, one or more roles to be used for verification of access rights for the virtual user; and
submit, by the middle-tier application, the request to the database system on the connection.

9. The computer-readable medium of claim 8, further comprising instructions that, when executed, cause the processing system to:
authenticate, by the middle-tier application, the end user with the middle-tier application; and
create, by the middle-tier application, a session pool that includes the connection.

10. The computer-readable medium of claim 8, further comprising instructions that, when executed, cause the processing system to:
associate the database user name with the virtual user; and
record one or more roles that specify database access rights of the virtual user.

11. The computer-readable medium of claim 10, wherein the instructions that create the virtual user comprise instructions that, when executed, cause the processing system to create a plurality of virtual users each corresponding to one of a plurality of end users of the middle-tier application.

12. The computer-readable medium of claim 8, further comprising instructions that, when executed, cause the processing system to verify, by the database system, the virtual user is a valid virtual user.

13. The computer-readable medium of claim 8, further comprising instructions that, when executed, cause the processing system to verify, by the database system, that the request complies with the database access rights of the virtual user.

14. The computer-readable medium of claim 8, further comprising instructions that, when executed, cause the processing system to authenticate, by the database system, the middle-tier application as a valid user of the database system.

15. A system having a database system deployed therein that provides virtual access to the database system by a middle-tier application, comprising:
at least one storage medium on which the database system is stored; and
at least one processing module that registers the middle-tier application with the database system with a database user name, receives a connection from the middle-tier application with an identity of a virtual user corresponding to an end user of the middle-tier application, and receives, from the middle-tier application on the connection, a request to be processed in the database system that was submitted to the middle-tier application from a client system configured as the end user of the middle-tier application.

16. The system of claim 15, wherein the middle-tier application authenticates the end user with the middle-tier application and creates a session pool that includes the connection.

17. The system of claim 15, wherein the at least one processing module creates the virtual user by registering the virtual user with the database system, associates the database user name with the virtual user, and records one or more roles that specify database access rights of the virtual user.

18. The system of claim 17, wherein the at least one processing module creates a plurality of virtual users each corresponding to one of a plurality of end users of the middle-tier application.

19. The system of claim 15, wherein the at least one processing module verifies the virtual user is a valid virtual user.

20. The system of claim 15, wherein the at least one processing module verifies that the request complies with the database access rights of the virtual user.
